(19) United States
(12) Patent Application Publication
(10) Pub. No.: US 2009/0173121 A1
(43) Pub. Date: Jul. 9, 2009

(54) Bump Proof Locks

(76) Inventors: Ben Cheng, San Jose, CA (US); Wei Pan Cheng, San Jose, CA (US)

Correspondence Address: CHEIN-HWA S. TSAO, 6684 MT PAKRON DRIVE, SAN JOSE, CA, 95120, US

(21) Appl. No.: 12/110,332

(22) Filed: Apr. 27, 2008

Related U.S. Application Data
(60) Provisional application No. 61/018,748, filed on Jan. 3, 2008.

(51) Int. Cl. E05B 27/00

(52) U.S. Cl. 70/493

(57) ABSTRACT

A bump proof lock has stationary part and movable part in lockable sliding contact with each other. The stationary part has first passages and a driver pin slidably disposed in each first passage. The movable part has:
A key way for receiving a key with key shank.
Second passages arranged in pair wise communication with first passages.
A key pin slidably disposed in each second passage. Each key pin has a pre-determined length such that the lengths define a unique key pin spatial profile. One end of each key pin is in sliding contact with the key shank and another end of each key pin is in slidable contact with its corresponding driver pin forming a local key-driver pin pair and a global key-driver contact spatial profile.

Numerous key-driver pin pairs are made of magnets attracting each other causing the pairs to resist separation under a mechanical shock.

### CROSS REFERENCE TO RELATED APPLICATIONS

This application is based upon the following filed provisional patent application:
Title: “Bump Proof Lock”, Application No. 61/018,748, application Date: Jan. 3, 2008, Inventors: Ben Cheng & Wei Pan Cheng
   whose contents are incorporated herein by reference for any and all purposes.

### BACKGROUND OF THE INVENTION

1. Field of the Invention

This invention relates to locks and particularly to pin-tumbler locks. Most particularly, this invention relates to pin-tumbler locks that are highly bump resistant.

2. Related Background Art

Recently, a lock picking technique known as “lock bumping” that had been used by locksmiths as well as thieves was reported by news media around the world. This technique is also being broadcasted over the Internet. Many articles can be found at web sites such as Youtube.

The lock bumping technique uses bump keys that are fairly easy to make with simple tools and are also widely available for purchase over the Internet. Most of the pin tumbler type of locks that probably are widely used in the world become rather useless under the attack of lock bumping.

The lock bumping technique is described in a white paper entitled “The Lockdown: Locked, but not secure” published by Marc Weber Tobias and further described here.

Reference is made to FIG. A, FIG. B and FIG. C illustrating a traditional pin-tumbler lock 80 being picked by a bump key 18. FIG. C is a general outline of the core of the traditional pin-tumbler lock 80. To avoid unnecessary obscuring details, a mechanism of attaching the core to a latch is not shown here. FIG. A and FIG. B depict cross section A-A of FIG. C with an added bump key 18. The traditional pin-tumbler lock 80 has a stationary part 1 and a movable part 2 in lockable sliding contact relationship with each other through their respective stationary confronting surface 3 and movable confronting surface 4 for movement of the movable part 2 between locked and unlocked positions through a shear surface 11. The movable part 2 is a cylindrical plug that is rotatably mounted in a cylindrical bore 12 inside a stationary shell of the stationary part 1. Hence, the shear surface 11 is of a cylindrical shape. The stationary part 1 has, in this case, six (6) first passages 6 extending away from the stationary confronting surface 3. Correspondingly, six (6) driver pins (8a, 8b, 8c, 8d, 8e, 8f) are slidably disposed in each of the six (6) first passages 6.

The movable part 2 has a longitudinal key way 5 with a keyway bar 15 for receiving an external key with a key shank. The key way 5 preferably is irregular in cross section (FIG. C) thus requires a key of particular matching cross section for insertion into the key way 5. The function of the keyway bar 15 will be more conveniently described later. In this case, however, a bump key 18 with a bump key shank 18a is inserted into the key way 5. The movable part 2 also has, in this case, six (6) second passages 7 arranged in pair wise communication with the six (6) first passages 6 inside the stationary part 1. The second passages 7 likewise extend away from the movable confronting surface 4. Correspondingly, six (6) key pins (9a, 9b, 9c, 9d, 9e, 9f) are slidably disposed in each of the six (6) second passages 7.

Notice that each key pin (9a-9f) has a pre-determined unique length, in general different from the other key pins, such that the corresponding six (6) key pin lengths define a unique key pin spatial profile. The bottom end of each key pin is intended to engage in sliding contact with a key shank and the top end of each key pin is intended to engage in slidable contact with its corresponding driver pin forming a local key-driver pin pair (for example 9a-8a, 9b-8b, etc.) and a global key-driver contact spatial profile (contact surface 9a-8a, contact surface 9b-8b, . . . , contact surface 9f-8f). For biasing the disposed driver pin 8a in physical contact against its pairing key pin 9a, a compression spring 10 is also disposed in each of the first passages 6 with their outer ends capped off with a passage cap 14, etc.

Hence, while not specifically illustrated here for those skilled in the art, upon insertion into the key way 5 of an authentic key with a mechanical shank profile matching the key pin spatial profile, the thus formed key-driver contact spatial profile conforms to the shear surface 11 thus allowing all key-driver pin pairs (9a-8a through 9f-8f) to be sheared apart and opening of the traditional pin-tumbler lock 80 by an authentic key. On the other hand, upon insertion into the key way 5 of an otherwise inauthentic key with a mechanical shank profile mismatching the key pin spatial profile, the thus formed key-driver contact spatial profile would not conform to the shear surface 11 thus disallowing all key-driver pin pairs (9a-8a through 9f-8f) to be sheared apart and opening of the traditional pin-tumbler lock 80 by an inauthentic key.

The bump key 18 is first inserted fully into the traditional pin-tumbler lock 80 (FIG. A). Observe that (both FIG. A and FIG. B), due to the removal of a slight bit of material from the bump key shank 18a, the bump key 18 is free to thrust forward under an externally applied mechanical shock 40 such as when struck with a mallet (tomahawk), plastic-handled screwdriver, piece of wood, or almost any other weighted object. Thus, all the key pins (9a-9f) are violently forced upwards upon their making contact with the thrusting ramps on the bump key shank 18a. This causes movement of the top driver pins (8a-8f) against the compression springs 10 and creates a momentary gap between the key pins and the driver pins within all the chambers formed by the first passages 6 and the second passages 7 (FIG. B). If the timing is correct, the cylindrical movable part 2 is now free to turn along the shear surface 11 and the traditional pin-tumbler lock 80 is thus opened by the bump key 18.

Numerous prior art designs exist to provide a bump proof lock. There have been many prior art lock designs involving magnetic pins. However, they are mostly “magnetic locks” that required keys with embedded magnets but are not designed for the prevention of lock bumping. Nevertheless, Some of them are bump-resistant. For example, the U.S. Pat. No. 4,026,134 granted to Joseph W. Woolfson on Dec. 5, 1975 discloses a lock design that consists of magnetic pin tumblers and a key with embedded magnets. In that design, the pin tumblers do not contact the key hence it cannot be bumped open. However, for the design to work, it relies on a precise balance of magnetic force among the embedded magnets in the key, the key pins and the driver pins. Additionally, gravity must also be considered in the force balance equation. All forces must be so precisely balanced that the pins are pushed to the exact “height” and that all key pin-driver pin interfaces are balanced exactly at the shear plan formed between the movable plug and the stationary shield of the lock. This is very difficult to achieve considering all the associated product manufacturing tolerances especially at a reasonable cost.

U.S. Pat. No. 6,481,254 granted to Yong Zheng and Jianxin Wang discloses a design that is a combination of pin tumbler and magnetic locks. As the magnetic pins are not in direct contact with the key and therefore cannot be bumped, the design can be considered bump-resistant. However, the design involves pin passages in two vertical plans and four directions that make the lock structure and key quite complicated. In addition, as for all magnetic lock designs using a magnetic key, duplication of the key is made very difficult.

U.S. Pat. No. 3,802,234 granted to John Gerlach on Apr. 9, 1974 discloses a “jam pin” idea that could be considered pick and bump resistant. It is a different design concept. However, when the plug of the lock is starting to turn by using an inauthentic key, the jam pin or pins will permanently jam the lock causing problem to the lock owner.

U.S. Pat. No. 7,272,965 granted to Moshe Dolev on Sep. 25, 2007 discloses a different bump-resistant lock design. The core of the design consists of a pin assembly of a pin with a recession and another pin with an engagement element for engaging the recession. The key pins and driver pins are thus mechanically locked together and move in unison when an impact-driven blow is applied to the lock. However, the pin engagement features require mechanically more complex parts and also make product retrofit more difficult.

Accordingly, it is an object of the present invention to provide a bump proof lock that uses existing key, is mechanically simple, low cost, easy to implement and easily retrofittable.

### SUMMARY OF THE INVENTION

A bump proof lock has:

A stationary part and a movable part in lockable sliding contact relationship with each other through their respective stationary confronting surface and movable confronting surface. Thus, the movable part can move between locked and unlocked positions through a shear surface.
The stationary part has numerous first passages extending away from the stationary confronting surface and a driver pin slidably disposed in each of the first passages.
The movable part has:
A longitudinal key way for receiving an external key with a key shank.
Numerous second passages that are arranged in pair wise communication with the first passages and that also extend away from the movable confronting surface.
A key pin slidably disposed in each of the second passages. Each key pin is of a pre-determined length such that the corresponding key pin lengths define a unique key pin spatial profile. A first end of each key pin is engaged in sliding contact with the key shank and a second end of each key pin is engaged in slidable contact with its corresponding driver pin forming a local key-driver pin pair and a global key-driver contact spatial profile.
   A number of pairs of key pin and driver pin are made of magnetic material poled to attract each other causing the corresponding magnetic key-driver pin pair to stick together against physical separation under an external mechanical shock.
   During operation of the bump proof lock:
a) Upon insertion into the key way of an authentic key with a mechanical shank profile matching the key pin spatial profile, the thus formed key-driver contact spatial profile conforms to the shear surface thus allowing all key-driver pin pairs, including the number of magnetic key-driver pin pairs, to be sheared apart and opening of the bump proof lock by the authentic key.
b) Upon insertion into the key way of an otherwise illegitimate bump key followed by an applied bump shock, the number of magnetic key-driver pin pairs dynamically move across the shear surface as one physical body thus preventing the bump proof lock to be opened by the bump key.

In a preferred embodiment, the number of magnetic key-driver pin pairs includes one magnetic key-driver pin pair.

In another preferred embodiment, the number of magnetic key-driver pin pairs includes at least two magnetic key-driver pin pairs.

In another preferred embodiment, the body of the stationary part and the movable part are made of nonferrous material to prevent otherwise induced stray magnetic forces, by the number of magnetic key-driver pin pairs, from interfering with the normal operation of the bump proof lock.

In a more specific embodiment, each key pin is sized to be of lesser length than its surrounding second passage but of greater length than the difference between the lengths of a communicating first passage and its enclosed driver pin.

In a more specific embodiment, each driver pin is sized to be of lesser length than its surrounding first passage but of greater length than the difference between the lengths of a communicating second passage and its enclosed key pin.

In another preferred embodiment, the stationary part further includes, within each first passage wherein the disposed driver pin material is non-magnetic, a compression spring for maintaining the disposed driver pin in physical contact against its pairing key pin.

An anti-bumping retrofit kit for a pin-tumbler lock having a stationary part and a movable part in lockable sliding contact relationship with each other for movement of the movable part through a shear surface. The stationary part includes numerous first passages and a driver pin slidably disposed in each first passage. The movable part includes a key way for receiving an external key with a key shank and numerous second passages arranged in pair wise communication with the first passages. A key pin is slidably disposed in each second passage, each key pin being of a pre-determined length such that the corresponding key pin lengths define a unique key pin spatial profile. A first end of each key pin is engaged in sliding contact with the key shank and a second end of each key pin is engaged in slidable contact with its corresponding driver pin forming a local key-driver pin pair and a global key-driver contact spatial profile. The anti-bumping retrofit kit includes, for each pair of a selected number of key-driver pin pairs of the pin-tumbler lock:

A pair of replacement key pin and replacement driver pin each of the same shape and size as the selected key-driver pin pair. The replacement key pin and replacement driver pin are made of a magnetic material and are poled to attract each other causing the corresponding magnetic replacement key-driver pin pair, upon their replacement in the pin-tumbler lock, to stick together against physical separation under an external mechanical shock.
During operation of the retrofitted bump proof lock:
1) Upon insertion of an authentic key into the retrofitted pin-tumbler lock, it allows opening like before.
2) Upon insertion of an otherwise illegitimate bump key followed by an applied bump shock, all magnetic replacement key-driver pin pairs dynamically move across the shear surface as one physical body thus preventing the retrofitted pin-tumbler lock to be opened by the bump key.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 1 is a cross-sectional view, taken along line A-A of FIG. C, of a bump proof lock of the present invention together with an authentic key before insertion;

FIG. 2 is a cross sectional view, taken along line A-A of FIG. C, of a bump proof lock of the present invention together with an authentic key after full insertion; and

FIG. 3 illustrates a cross sectional view, taken along line A-A of FIG. C, of a bump proof lock of the present invention under bumping attack with a fully inserted bump key.

### DETAILED DESCRIPTION OF THE PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

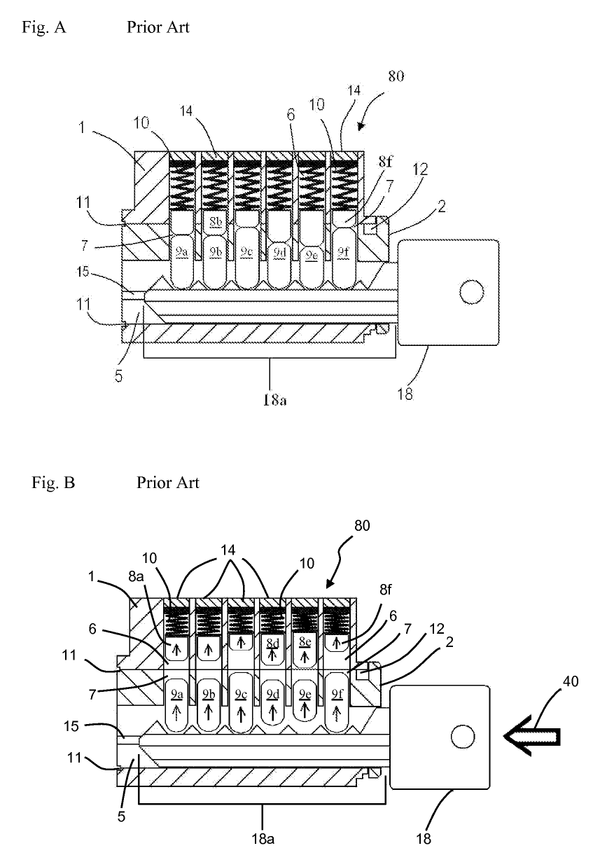

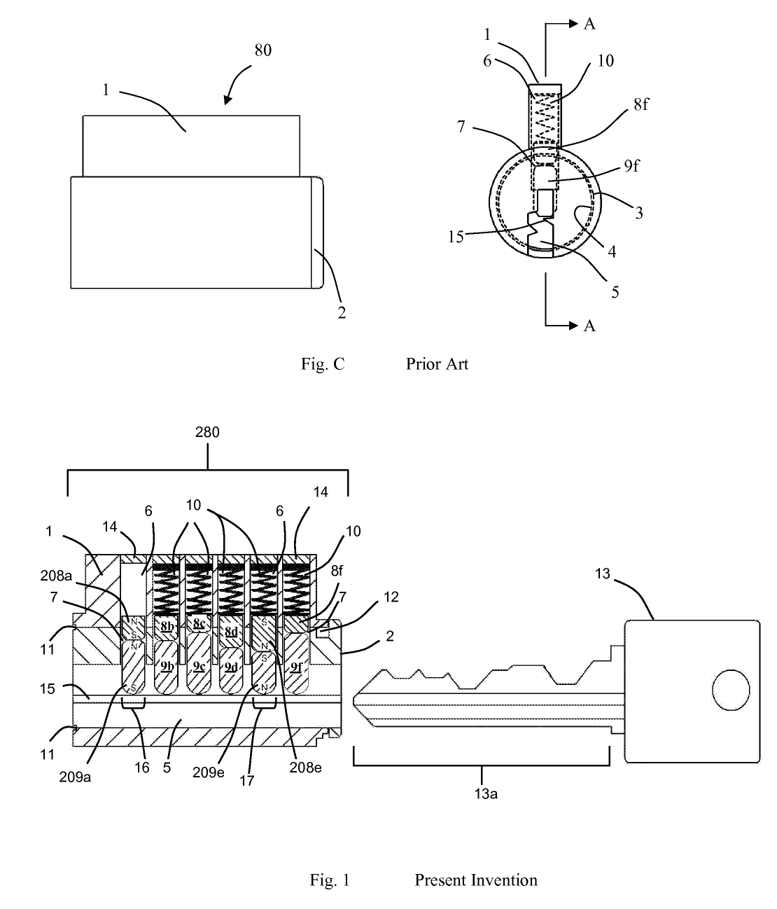

FIG. 1 is a cross-sectional view, taken along line A-A of FIG. C, of a bump proof lock 280 of the present invention together with an authentic key 13 before its insertion. FIG. 2 is, except for the full insertion of the authentic key 13, the same as FIG. 1.

The bump proof lock 280 has a stationary part 1 and a movable part 2 in lockable sliding contact relationship with each other through their respective stationary confronting surface 3 and movable confronting surface 4 for movement of the movable part 2 between locked and unlocked positions through a shear surface 11. The movable part 2 is a cylindrical plug that is rotatably mounted in a cylindrical bore 12 inside a stationary shell of the stationary part 1. Hence, the shear surface 11 is of a cylindrical shape. The stationary part 1 has, in this case, six (6) first passages 6 extending away from the stationary confronting surface 3. Correspondingly, six (6) driver pins (208a, 8b, 8c, 8d, 208e, 8f) are slidably disposed in each of the six (6) first passages 6.

The movable part 2 has a longitudinal key way 5 with a keyway bar 15 for receiving an external key with a key shank. The key way 5 preferably is irregular in cross section (see earlier FIG. C) thus requires a key of particular matching cross section for insertion into the key way 5. The movable part 2 also has, in this case, six (6) second passages 7 arranged in pair wise communication with the six (6) first passages 6 inside the stationary part 1. The second passages 7 have the same longitudinal pitch as the first passages 6 in the stationary part 1 making the two groups of passages registerable with each other when the bump proof lock 280 is in its locked position as shown in FIG. 1. The second passages 7 likewise extend away from the movable confronting surface 4. Correspondingly, six (6) key pins (209a, 9b, 9c, 9d, 209e, 9f) are slidably disposed in each of the six (6) second passages 7.

Notice that each key pin (209a, 9b, 9c, 9d, 209e, 9f) has a pre-determined unique length, in general different from the other key pins, such that the corresponding six (6) key pin lengths define a unique key pin spatial profile. Furthermore, when the authentic key 13 is not inserted in the bump proof lock 280, the bottom end of the key pins seat on the longitudinal keyway bar 15 while the top end of the key pins are positioned below the shear surface 11. Each driver pin also has a pre-determined unique length, in general different from the other driver pins, that is longer than the gap from the top of the key pin to the shear surface 11 when the key pin is seating on the keyway bar 15. In such position, the driver pins are bridging the first passages 6 and the second passages 7 thus prohibit the movable part 2 from turning hence keeping the bump proof lock 280 in its locked state (FIG. 1).

The bottom end of each key pin is intended to engage in sliding contact with a key shank 13a of the authentic key 13 and the top end of each key pin is intended to engage in slidable contact with its corresponding driver pin forming a local key-driver pin pair (for example 209a-208a, 9b-8b, 209e-208e, etc.) and a global key-driver contact spatial profile (contact surface 209a-208a, contact surface 9b-8b, . . . , contact surface 9f-8f). The length of each key pin is sized to be shorter than its surrounding second passage but longer than the difference between the lengths of a communicating first passage and its enclosed driver pin. The length of each driver pin is sized to be shorter than its surrounding first passage but longer than the difference between the lengths of a communicating second passage and its enclosed key pin. To further bias the disposed driver pins in physical contact against their pairing key pin key pins, a compression spring 10 is also slidably disposed in each of the first passages 6 with their outer ends sealed and capped off with a passage cap 14. The same compression spring 10 also keeps all driver and key pins in their lowest position when a key is not inserted in the bump proof lock 280, etc. As alternative embodiments, an elastically bending member or a partially inflated balloon can be used in lieu of the compression spring 10.

One or more, preferably at least two of the driver-key pin pairs are made of permanent magnetic material. Furthermore, each pair of magnetic key-driver pin pair are poled to attract each other. Thus, FIG. 1 through FIG. 3 illustrate an embodiment of two magnetic key-driver pin pairs: key-driver pin pair #1 16 and magnetic key-driver pin pair #2 17. In magnetic key-driver pin pair #1 16 (magnetic key pin 209a, magnetic driver pin 208a) the magnetic polarization sequence is <N-S> <N-S>, whereas in magnetic key-driver pin pair #2 17 (magnetic key pin 209e, magnetic driver pin 208e) the magnetic polarization sequence is <S-N> <S-N>. Therefore, the magnetic driver pin 208a and its pairing magnetic key pin 209a are attracted to each other and bonded together by magnetic force. Likewise, the magnetic driver pin 208e and its pairing magnetic key pin 209e are also bonded together by magnetic force. However, the magnetic key-driver pin pairs can nevertheless be sheared apart laterally when their internal joint surface lines up with the shear surface 11. To those skilled in the art, the magnetic polarization sequence of each magnetic key-driver pin pair can be either <N-S> <N-S> or <S-N> <S-N> as long as the resulting key pin and driver pin attract each other. As a side note, for those first passages and second passages housing a magnetic key-driver pin pair such as the magnetic key-driver pin pair #1 16, the corresponding first passage can be implemented without the compression spring 10 as shown.

FIG. 2 illustrates the situation where an authentic key 13 with an authentic key shank 13a is fully inserted into the key way 5 of the bump proof lock 280. As the mechanical shank profile of the authentic key 13 matches the key pin spatial profile, the thus formed global key-driver contact spatial profile conforms to the shear surface 11 as shown in FIG. 2. Thus, the shear surface 11 is free of any mechanical blockage, the movable part 2 is free to turn with respect to the stationary part 1 allowing all key-driver pin pairs, including the magnetic key-driver pin pair #1 16 and magnetic key-driver pin pair #2 17, to be sheared apart and opening of the bump proof lock 280 by the authentic key 13.

On the other hand, while not illustrated here to avoid excessive details, upon insertion into the key way 5 of an otherwise inauthentic key with a mechanical shank profile mismatching the key pin spatial profile, the thus formed global key-driver contact spatial profile would not conform to the shear surface 11 thus disallowing all key-driver pin pairs, including the magnetic key-driver pin pair #1 16 and magnetic key-driver pin pair #2 17, to be sheared apart and opening of the bump proof lock 280 by an inauthentic key.

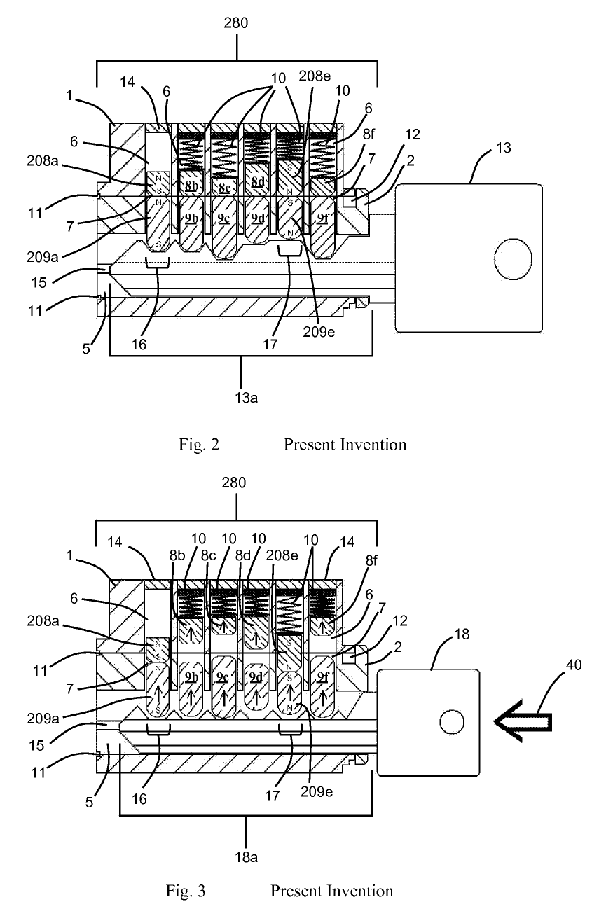

FIG. 3 illustrates the situation where a bump proof lock 280 of the present invention is under bumping attack from a mechanical shock 40 applied to a fully inserted illegitimate bump key 18 of bump key shank 18a. Under bumping attack, as was already described in the prior art and illustrated in FIG. A and FIG. B before, the none magnetic driver pins 8b, 8c, 8d, 8f are “kicked” away from the none magnetic key pins 9b, 9c, 9d, 9f and create a momentary gap between these driver pins and key pins within their corresponding chambers formed by the first passages 6 and the second passages 7. However, the magnetic key-driver pin pair #1 16 and magnetic key-driver pin pair #2 17 remain stuck together against physical separation under the mechanical shock 40. Instead, the driver pins (208a, 208e) and key pins (209a, 209e) of the magnetic key-driver pin pairs (16, 17) move up and down in unison with no gap in between. Thus, the shear surface 11 is mechanically blocked, disallowing the bump proof lock 280 to be opened by the bump key 18. When two or more of the magnetic key-driver pin pairs with different pin length configurations are implemented in a lock, such as the currently illustrated magnetic key-driver pin pairs 16 and 17, each magnetic key-driver pin pair remains stuck together and the key pin-driver pin contact surfaces of different magnetic key-driver pin pairs do not simultaneously cross the shear surface 11 while the lock is under the shock of bumping attack. Consequently, at least one of the magnetic key-driver pin pairs will end up mechanically blocking the shear surface 11 all the time making the lock virtually completely bump proof.

As described, the present invention expects to eliminate a critical weakness of a traditional pin-tumbler lock against lock bumping. The reason lock bumping can defeat the traditional pin tumbler-lock is that the key pins and driver pins of the lock are “kicked apart” thus creating a gap in between under a violent mechanical shock transmitted from a bump key. By making at least one pair of key pin and driver pin out of mutually attracting permanent magnets, the present invention insures that they are always bonded together by magnetic force with no gap in between as they move up and down in unison following a bumping attack. With no separation created between the magnetic key-driver pin pairs, bumping cannot defeat the lock. Besides being mechanically simple, low cost and easy to implement with high effectiveness, the present invention does not need a special key with embedded magnets.

Other than the magnetic key-driver pin pairs, numerous other parts of the bump proof lock 280 surrounding the magnetic key-driver pin pairs can be made of nonferrous material, such as brass, to prevent otherwise induced stray magnetic forces, by the magnetic key-driver pin pairs, from interfering with the normal operation of the bump proof lock 280. These other parts include, for example, stationary part 1, movable part 2 and compression spring 10. However, an example to the contrary is the authentic key 13 which can be made of a ferrous material without hurting the functionality of the bump proof lock 280.

The present invention is also easily retrofittable to most of the pin-tumbler locks making them bump proof. The anti-bumping retrofit kit simply includes, for each pair of a selected number of key-driver pin pairs of the pin-tumbler lock:
A pair of replacement key pin and replacement driver pin each of the same shape and size as the selected key-driver pin pair. The replacement key pin and replacement driver pin are to be made of a permanent magnetic material poled to attract each other.

It will be appreciated by those of ordinary skill in the art that the present invention can be embodied in numerous other specific forms and those of ordinary skill in the art would be able to practice such other embodiments without undue experimentation. As an example, for as long as the resulting magnets attract each other, each pin of a magnetic key-driver pin pair can be made of a magnet with two opposite pole faces located at each of its two ends to serve other useful purposes. As another example, the weight of various magnetic key-driver pin pairs can be deliberately made different so that, while under a bumping attack, the probability of the key pin-driver pin contact surfaces from different magnetic key-driver pin pairs crossing the shear surface simultaneously is rendered virtually zero. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

We claim:

1. A bump proof lock comprising:
a first stationary part and a second movable part in lockable sliding contact relationship with each other through their respective stationary confronting surface and movable confronting surface for movement of the movable part between locked and unlocked positions through a shear surface;
said first stationary part further comprises:
a plurality of first passages which extend away from said stationary confronting surface; and
a driver pin slidably disposed in each of said first passages;
said second movable part further comprises:
a longitudinal key way for receiving an external key with a key shank;
a plurality of second passages, arranged in pair wise communication with said plurality of first passages, which extend away from said movable confronting surface; and
a key pin slidably disposed in each of said second passages, each key pin being of a pre-determined length such that the corresponding key pin lengths define a unique key pin spatial profile, with a first end of each key pin engaged in sliding contact with the key shank and a second end of each key pin engaged in slidable contact with its corresponding driver pin forming a local key-driver pin pair and a global key-driver contact spatial profile; and
a number of pairs of key pin and driver pin are made of magnetic material poled to attract each other causing the corresponding magnetic key-driver pin pair to stick together against physical separation under an external mechanical shock
whereby:
a) upon insertion into the key way of an authentic key with a mechanical shank profile matching said key pin spatial profile, the thus formed key-driver contact spatial profile conforms to said shear surface thus allowing all key-driver pin pairs, including said number of magnetic key-driver pin pairs, to be sheared apart and opening of the bump proof lock by the authentic key; whereas
b) upon insertion into the key way of an otherwise illegitimate bump key followed by an applied bump shock, said number of magnetic key-driver pin pairs dynamically move across the shear surface as one physical body thus preventing the bump proof lock to be opened by the bump key.

2. The bump proof lock of claim 1 wherein said number of magnetic key-driver pin pairs further comprises one magnetic key-driver pin pair.

3. The bump proof lock of claim 1 wherein said number of magnetic key-driver pin pairs further comprises at least two magnetic key-driver pin pairs.

4. The bump proof lock of claim 1 wherein said number of magnetic key-driver pin pairs further comprises all magnetic key-driver pin pairs.

5. The bump proof lock of claim 1 wherein the body of said stationary part and said movable part are made of nonferrous material to prevent otherwise induced stray magnetic forces, by said number of magnetic key-driver pin pairs, from interfering with the normal operation of the bump proof lock.

6. The bump proof lock of claim 1 wherein each key pin is sized to be of lesser length than its surrounding second passage but of greater length than the difference between the lengths of a communicating first passage and its enclosed driver pin.

7. The bump proof lock of claim 1 wherein each driver pin is sized to be of lesser length than its surrounding first passage but of greater length than the difference between the lengths of a communicating second passage and its enclosed key pin.

8. The bump proof lock of claim 1 wherein said stationary part further comprises, within each first passage wherein the disposed driver pin material is non-magnetic, a biasing means for maintaining the disposed driver pin in physical contact against its pairing key pin.

9. An anti-bumping retrofit kit for a pin-tumbler lock having a stationary part and a movable part in lockable sliding contact relationship with each other for movement of the movable part through a shear surface, the stationary part includes numerous first passages and a driver pin slidably disposed in each first passage, the movable part includes a key way for receiving an external key with a key shank, numerous second passages, arranged in pair wise communication with the first passages, and a key pin slidably disposed in each second passage, each key pin being of a pre-determined length such that the corresponding key pin lengths define a unique key pin spatial profile, with a first end of each key pin engaged in sliding contact with the key shank and a second end of each key pin engaged in slidable contact with its corresponding driver pin forming a local key-driver pin pair and a global key-driver contact spatial profile, the anti-bumping retrofit kit comprises, for each pair of a selected number of key-driver pin pairs of the pin-tumbler lock:
a pair of replacement key pin and replacement driver pin each of the same shape and size as said selected key-driver pin pair, wherein said replacement key pin and replacement driver pin are further made of a magnetic material and are poled to attract each other causing the corresponding magnetic replacement key-driver pin pair, upon their replacement in the pin-tumbler lock, to stick together against physical separation under an external mechanical shock whereby:
1) upon insertion of an authentic key into the retrofitted pin-tumbler lock, it allows opening like before; whereas
2) upon insertion of an otherwise illegitimate bump key followed by an applied bump shock, all magnetic replacement key-driver pin pairs dynamically move across the shear surface as one physical body thus preventing the retrofitted pin-tumbler lock to be opened by the bump key.

10. A method of preventing lock bumping of a pin-tumbler lock having a stationary part and a movable part in lockable sliding contact relationship with each other for movement of the movable part through a shear surface, the stationary part includes numerous first passages and a driver pin slidably disposed in each first passage, the movable part includes a key way for receiving an external key with a key shank, numerous second passages, arranged in pair wise communication with the first passages, and a key pin slidably disposed in each second passage, each key pin being of a pre-determined length such that the corresponding key pin lengths define a unique key pin spatial profile, with a first end of each key pin engaged in sliding contact with the key shank and a second end of each key pin engaged in slidable contact with its corresponding driver pin forming a local key-driver pin pair and a global key-driver contact spatial profile, the method comprises:
a) selecting a number of key-driver pin pairs; and
b) for each so selected key-driver pin pair, replacing it with a pair of replacement key pin and replacement driver pin each of the same shape and size as said selected key-driver pin pair, wherein said replacement key pin and replacement driver pin are further made of a magnetic material and are poled to attract each other causing the corresponding magnetic replacement key-driver pin pair to stick together against physical separation under an external mechanical shock whereby:
1) upon insertion of an authentic key into the pin-tumbler lock with the replacement, it allows opening like before; whereas
2) upon insertion of an otherwise illegitimate bump key followed by an applied bump shock, all magnetic replacement key-driver pin pairs dynamically move across the shear surface as one physical body thus preventing the pin-tumbler lock with the replacement to be opened by the bump key.

11. The method of preventing lock bumping of claim 10 wherein selecting a number of key-driver pin pairs further comprises selecting one magnetic key-driver pin pair.

12. The method of preventing lock bumping of claim 10 wherein selecting a number of key-driver pin pairs further comprises selecting at least two magnetic key-driver pin pairs.

13. The method of preventing lock bumping of claim 10 wherein selecting a number of key-driver pin pairs further comprises selecting all magnetic key-driver pin pairs.
